(19) United States
(12) Patent Application Publication
(10) Pub. No.: US 2015/0348142 A1
(43) Pub. Date: Dec. 3, 2015

(54) System and Method of Vehicle Value Assessment

(71) Applicant: NthGen Software Inc., Toronto (CA)

(72) Inventors: Mark Endras, Toronto (CA); Hon-Wai Chia, Toronto (CA)

(21) Appl. No.: 14/728,542

(22) Filed: Jun. 2, 2015

Related U.S. Application Data
(60) Provisional application No. 62/006,300, filed on Jun. 2, 2014.

(51) Int. Cl. G06Q 30/02

(52) U.S. Cl. CPC G06Q 30/0278

(57) ABSTRACT

A method is provided for a computer-mediated value assessment of a vehicle offered for sale by a seller. A computing device retrieves a universe of historical pricing data of vehicles having at least one parameter in common with the vehicle. From this universe of historical pricing data of vehicles having the same or similar at least one parameter, a maximum potential wholesale value is established. Using the vehicle identification number (VIN) of the vehicle, data is retrieved regarding the vehicle and its condition. This data is converted into at least one quantitative modifier, and at least one qualitative modifier. The maximum potential wholesale value is then reduced by the at least one quantitative modifier and the at least one qualitative modifier to arrive at an assessed value of the vehicle. This assessed value can then be communicated to a person requesting an assessment prior to a sale of the vehicle.

### CROSS-REFERENCE TO RELATED APPLICATIONS

This application claims the benefit of U.S. Provisional Patent Application No. 62/006,300, filed Jun. 2, 2014 entitled “System and Method of Vehicle Value Assessment,” which is incorporated herein by reference in its entirety.

### FIELD OF THE INVENTION

The field is generally related to e-commerce and in particular is related to automated methods of deriving an assessed value for a vehicle.

### BACKGROUND

Historically barter, haggling, sale by a set-price and auctions have been some of the traditional ways to negotiate the exchange of goods and commodities. An appraisal is an estimate of an item's worth, usually performed by an expert and may be used as a mechanism to define the asking price for an item.

Many factors influence the value of a vehicle. Assessment value of a vehicle is subjective and prior art methods lack automation when calculating an accurate assessment of the value of a vehicle. An auction is a process of buying and selling goods or services by offering them up for bid, taking bids, and then selling the item to the highest bidder. Bidding is the act of participating in an auction by offering to purchase an item for sale. Prices are bid by buyers and asked (or offered) by sellers. Auctions are publicly and privately seen in several contexts and almost anything can be sold at an auction. E-Bidding or Electronic Bidding—is a type of auction, whereby a person may make a bid without being physically present at an auction or where the entire auction is taking place on the Internet.

Online auctions for vehicles are common where a wide variety of off-lease, commercial and dealer vehicles may be sold to other dealers and the public. Some dealers may auction one or more vehicles to other dealers who in turn sell these to the public via their showrooms.

One issue with online auctions for vehicles is that accurate vehicle value assessments are not available. Auctions are also prone to collusion and manipulation if the bidders are not fully aware of the value of the item being auctioned. The vehicle may be remote, where only digital representation e.g. photos and videos of it being available. Thus it is easy to hide any blemishes or other kind of damage. For example if a vehicle has been wrecked and repaired, it has lost a certain value, but if the bidders are not aware of the history of the vehicle they may end up over paying for it.

It would be desirable to provide a simple means for automatic assessment of a vehicle value.

### SUMMARY

Broadly speaking, the present invention relates to a system and method of automatic vehicle value assessment. The invention disclosed herein proposes a system and method of automatic vehicle assessment that may preferably be used in vehicle auctions. The system may run on a server that is accessible to users preferably via connected mobile devices.

The invention provides an automated method and system for calculating the assessed value of a vehicle using its specific installed options; its condition e.g. any accidents, any dents, any re-paints etc; its history e.g. whether the vehicle is single owner, multi-owner, was it a previous daily rental, the region where the vehicle was driven etc. to calculate the assessed value.

In one embodiment an application may be provided (either generic or purpose built), which allows a user to interact with the functionality provided by the system. The application may be specific for a particular mobile device e.g. an iPhone or a Google Android phone, or a tablet computer etc. or generic e.g. Flash or HTML5 based app that can be used in a browser.

In one embodiment users may use connected devices e.g. a Smartphone, a tablet, or a personal computer to connect with the system e.g. using a browser on a personal computer to access the website or via an app on a mobile device. In one embodiment the app may be downloaded from an AppStore. Devices where invention can be advantageously used may include but not limited to an iPhone, iPad, Smartphones, Android phones, personal computers e.g. laptops, tablet computers, touch-screen computers running any number of different operating systems e.g. MS Windows, Apple iOS, Linux, Ubuntu, etc.

A graphical user interface may be provided for a user to request a vehicle assessment. In one embodiment the vehicle may be assessed including its VIN number, make, model, year etc. This vehicle identification information may be used to acquire further detailed information from different third parties.

The information that is contained in the VIN may be decoded, for example, using third party services. This information may be used to get further information about the vehicle from third parties. Some information about a vehicle may not be available from the VIN, e.g. color, engine size, installed options. Such information may be obtained from third parties by querying their databases by supplying the VIN and getting this information.

The Maximum Potential Wholesale Value (MPWV) of the said vehicle may be calculated. When calculating the MPWV of a vehicle various factors may be taken into consideration, including its make, model, year, mileage, installed options, the region where the vehicle had been used in the past, history of sale, market performance of the brand etc. amongst other factors. The system and method may preferably use a database that contains the historical data on the sale of vehicles in a region, or a country or globally. The historical data for different makes and models of vehicles may be acquired from third parties or may accumulate in the system as more sellers and bidders interact with it. The historical data may also contain prices of different makes and models per year and region. In one embodiment the MPWV of a vehicle may be the maximum value that a vehicle of that make, model, year may be assigned if its overall condition, history etc. are in perfect order and no negative factors e.g. dents or damage that can devalue it can be found. A real vehicle may in reality never be assessed to a value that is either equal to or greater than the MPWV.

Using the VIN, data may be acquired regarding the vehicle and its condition. Such data may be acquired from internal resources or external third party systems. Such acquired data may be separated into Quantitative Characteristics and Qualitative Characteristics. A Quantitative Analysis Engine may be used to analyze the quantitative characteristics and derive a monetary amount Qt. A Qualitative Analysis Engine may be used to analyze the qualitative characteristics and derive a monetary amount Ql.

In one embodiment derive an assessment for the vehicle by subtracting the amounts Qt and Ql from the MPWV of the vehicle that is being assessed.

In another embodiment, in order to calculate the assessed value of a vehicle, factors or ratios may be used instead of the dollar amounts, in which case, the following formula may be used:

Assessed Value=MPWV*[1−{Σ(Quantitative Modifiers)+Σ(Qualitative Modifiers)}]

In another embodiment, a Quantitative Modifier may be a ratio of the cost it may take to repair/replace an item and the MPWV, and a Qualitative Modifier may be a ratio of the value and the MPWV.

In one embodiment an assessment of the vehicle may be derived and displayed to the user e.g. using a graphical user interface that may be part of the app. The assessment value of a vehicle may be displayed using a currency of the country or location where the vehicle is being assessed. For example in the US display the assessed value in US dollars, while in EU display the assessed value in Euros.

In one embodiment the assessed value of a vehicle may be received via e-mail, text message, IM, phone call etc. if the user requesting the assessment does not have the app installed on his mobile device.

According to a first aspect of the invention, a method is provided for computer-mediated value assessment of a vehicle offered for sale by a seller. A computing device retrieves a universe of historical pricing data of vehicles having the same or similar at least one parameter. From this universe of historical pricing data of vehicles having the same or similar at least one parameter, a maximum potential wholesale value is established. Using a vehicle identification number of the vehicle, data is retrieved regarding the vehicle and its condition. This data is converted into at least one quantitative modifier, and at least one qualitative modifier. The maximum potential wholesale value is then reduced by the at least one quantitative modifier and the at least one qualitative modifier to arrive at an assessed value of the vehicle. The assessed value is then communicated to a person requesting the assessment prior to a sale of the vehicle.

The at least one parameter may include at least one of make, model, or year.

Preferably, establishing a maximum potential wholesale value takes into account sales transactional data, length of time vehicle model in the market, whether new model has arrived in market, whether model discontinued, seasonality, economic trends, cultural trends, environmental factors and trends, automotive industry trends, news, or announcements.

The at least one quantitative modifier may include a modifier related to condition of body, tires, engine, transmission, windshield, or interior.

The at least one qualitative modifier may include a modifier related to vehicle color, mileage, history, accident data, service history, installed options, or type of transmission.

Preferably, the quantitative modifier is a monetary value. This may be an estimated or actual cost to replace, repair or upgrade a quantitative characteristic of the vehicle. The cost may be derived from at least one of realtime repair transactional data, industry accepted repair estimates, or crowdsourced repair data.

Alternatively, the quantitative modifier or the qualitative modifier (or both) may be ratios relative to the maximum potential wholesale value.

The vehicle identification number may be entered using at least one of a barcode scanner, digital camera, on board diagnostics, or user input.

The data may be retrieved by querying the vehicle identification number in a third party database.

In some embodiments, the location of the person requesting the assessment is also detected or retrieved. The assessment may be modified to take account of the location of the person requesting the assessment before the assessment is communicated. The assessment may be communicated to the person requesting the assessment in a legal currency of the location.

In some embodiments, the assessed value may be communicated with an expiration date. The person requesting the assessment may be allowed to transact with respect to the vehicle at the assessed value until the expiration date.

### BRIEF DESCRIPTION OF THE FIGURES

FIG. 1 is a flow diagram illustrating a basic method of vehicle value assessment according to the

FIG. 2 is a flow diagram illustrating the use of a vehicle identification number to acquire data.

FIG. 3 is a flow diagram illustrating potential factors in a determination of maximum potential wholesale value (MPWV).

FIG. 4 is a flow diagram illustrating potential quantitative modifiers.

FIG. 5 is a flow diagram illustrating potential qualitative modifiers.

FIG. 6 is a flow diagram illustrating data that may be used to establish monetary values of the quantitative (or qualitative) modifiers.

### DETAILED DESCRIPTION

Before embodiments are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software. In the present case, the code used to implement the invention is specialized to execute functions described herein which enable a smoother and more efficient technological process.

The present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

In order to provide a context for the various aspects of the disclosed invention, the following discussion is intended to provide a brief, general description of a suitable environment in which the various aspects of the disclosed invention may be implemented. While the invention has been described in the general context of computer-executable instructions of a program that runs on one or more computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the system and method may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch or other electronic gadgets incorporating the capacity to compute), microprocessor-based or programmable consumer or industrial electronics, and the like. The illustrated aspects may also be practiced in distributed computing environments where tasks/routines/processes etc. are performed by remote processing devices that are linked through a communications network e.g. a local area network (LAN) or the Internet. However, some, if not all aspects may be practiced on stand-alone computer(s). In a distributed computing environment, program modules may be located in both local and remote memory storage devices.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. Some embodiments may use well-known open-source Web development platforms using Linux, Apache, MySQL and PHP. Other examples of environments and frameworks using which computer code may also be generated are Ruby on Rails which is based on the Ruby programming language, or node.js which is an event-driven server-side JavaScript environment.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Computing devices that enable a user to engage with internet in general may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a USB memory key, flash memory, or other type of memory media all collectively referred to as “removable media” in this disclosure. The app may also be downloaded from the internet. The removable media can be inserted to the console of a computing device where it is read. The console can then read program instructions stored on the removable media and present a user interface to the user. The user interface may preferably be a graphical user interface (GUI). Example of such computing devices are personal computers e.g. a laptop or a Mac, a Smartphone, a tablet, a SmartTV, etc.

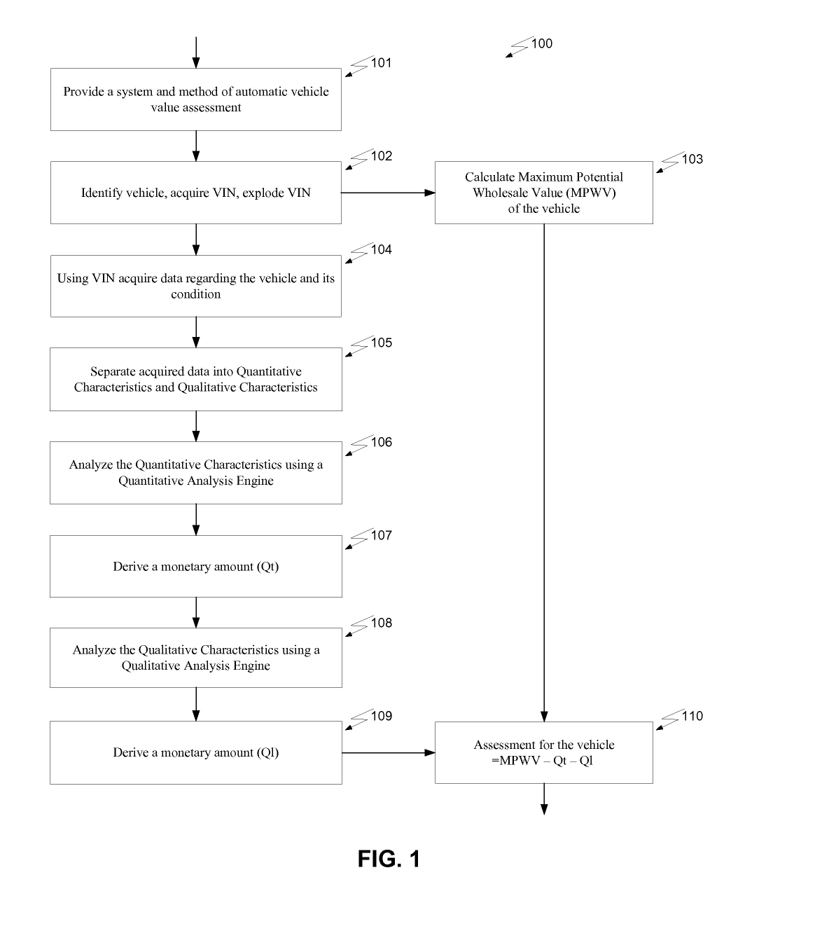

FIG. 1 shows a flow diagram of a basic outline of the method 100. A system and method is provided for automatic vehicle value assessment 101. Many factors may influence the value of a vehicle. If vehicle has been wrecked and repaired, it has lost a certain value. Some exemplary factors considered in the calculation of a vehicle's assessed value include, but are not limited to:
exterior condition
interior condition
condition of mechanical components
condition of tires
after market equipment
installed options
mileage
color

Major repairs to vehicle may reduce its assessed value, while normal maintenance performed at prescribed intervals such as oil changes, tune ups and replacement of belts and hoses etc. contribute positively in the assessment of the value of a vehicle. Major repairs to any of the following may reduce its assessed value:
engine
transmission
steering
brakes
suspension
exhaust system
electrical system
repainting of the vehicle

The system may run on a server that is accessible to users e.g. sellers and bidders. In one embodiment sellers can start an auction while bidders participate in the auction by placing bids on the vehicle being auctioned by the sellers.

Preferably users may connect to the system using a connected device e.g. a Smartphone, a tablet, or a personal computer e.g. using a browser on a personal computer to access the website or via an app on a mobile device. In one embodiment the app may be downloaded from an AppStore.

In one embodiment users may use connected devices e.g. a Smartphone, a tablet, or a personal computer to connect with the system e.g. using a browser on a personal computer to access the website or via an app on a mobile device. In one embodiment the app may be downloaded from an AppStore.

In the preferred embodiment the system and method may be implemented on a server which is accessible over the Internet through a computing device, e.g. a browser on a personal computer or a browser on a mobile device like a Smartphone, a tablet or the like. Devices where the invention can be advantageously used include but are not limited to personal computers e.g. laptops, tablet computers, touch-screen computers running any number of different operating systems e.g. MS Windows, Apple iOS, Linux, Ubuntu, etc. Smartphones like an iPhone, an Android phone, tablets like iPad and the like.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. Instructions for performing different functions may be included in a computer readable storage medium or other computer program product configured for execution by one or more processors.

The vehicle is identified, its VIN is acquired and exploded 102. A VIN (Vehicle Identification Number) is a unique code including a serial number, which is used by the automotive industry to identify individual motor vehicles. The first three characters uniquely identify the manufacturer of the vehicle using the world manufacturer identifier or VIN code. There are 17 numbers and letters (17 positions) in a VIN and these can be divided into three groups: World Manufacturer Identifier, Vehicle Descriptor Section, and Vehicle Identifier Section.

This VIN may be acquired by performing a VIN scan using a mechanised method to automatically machine read the VIN from the vehicle. In one embodiment a VIN may be optically read with barcode scanners or digital cameras, or digitally read via OBD-II (On Board Diagnostics) in available in some vehicles. In one embodiment there may be a Smartphone based app that can capture the VIN from a vehicle and transmit it to the server for processing.

In another embodiment the VIN may be inputted by a person by physically reading it from the vehicle. Such an embodiment may provide a user interface for inputting the VIN. User input may be provided via text or voice or other methods.

In one embodiment, exploding the VIN implies decoding the information that is contained in the VIN. This information may be used to get further information about the vehicle from third parties. VIN can be decoded using third party services.

Decoding or exploding the VIN reveals the information that is encoded in a VIN. The VIN can reveal a number of things about a car, including its airbag type, country of origin, engine size, model year and trim level. Typically, the VIN is stamped into a plate that's mounted on the dashboard near the windshield or on the driver-side door jamb. It's also stamped on the engine's firewall.

Some information about a vehicle may not be available from the VIN, e.g. color, engine size, installed options may not be available. Such information may be obtained from third parties by querying their databases by supplying the VIN and getting this information.

The Maximum Potential Wholesale Value (MPWV) of the vehicle is calculated 103. The price of a vehicle is dependent on its make, model, year, mileage, installed options, the region where the vehicle had been used in the past, amongst other factors.

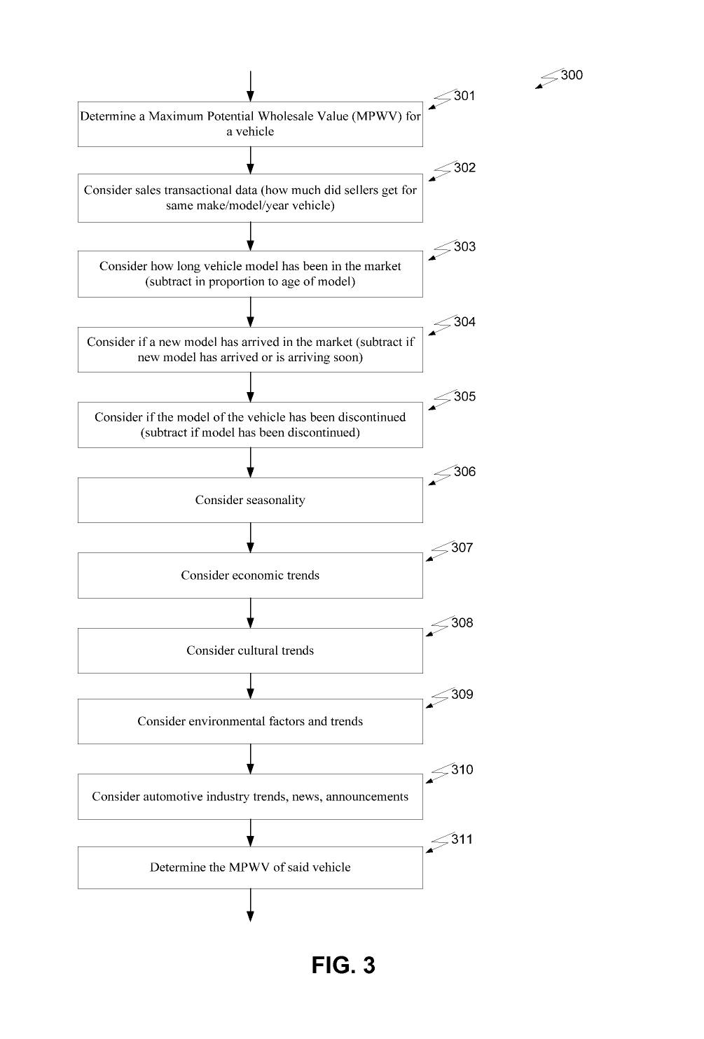

When calculating the MPWV of a vehicle its market performance, history of sale, etc. may be used. The system and method may preferably use a database that contains the historical data on the sale of vehicles in a region, or a country or globally. The historical data for different makes and models of vehicles may be acquired from third parties or may accumulate in the system as more sellers and bidders interact with it. The historical data may also contain prices of different makes and models per year and region. FIG. 3 provides further details of the factors that may be considered when calculating the MPWV of a vehicle.

The VIN is used to acquire data regarding vehicle and its condition 104. In one embodiment the system and method may use the VIN to acquire information about the vehicle from internal resources e.g. data saved to a server.

In another embodiment the VIN and other vehicle identification information may be sent to different third party sources to acquire more detailed information about the vehicle.

The acquired data may be separated into Quantitative Characteristics and Qualitative Characteristics 105. In one embodiment the acquired data may be separated into two separate sets, the first set being a set of Quantitative Characteristics while the second set is a set of Qualitative Characteristics.

Quantitative Characteristics may be defined as features of a vehicle that can be dealt with given a fixed amount of money. For example if a vehicle has worn out tires, it can be quite accurately determined what it will cost to get new tires for that particular vehicle. Thus for the Quantitative Characteristics there is a well defined dollar figure (or a well defined range of dollar figure) that can be used to determine if that particular element (tires, windscreen, dent, broken taillight or headlight, etc.) needs to be replaced, repaired, etc.

Qualitative Characteristics may be defined as features of a vehicle that cannot easily be modified for example its color or the type of transmission. It is known in the industry that certain colors of a vehicle sell better than others, thus if a vehicle has been customized to a particular color that is not mainstream, its resale market will be lower; thus it will be assessed at a lower value than a vehicle with a color that is mainstream. Similarly if a vehicle has manual transmission then getting it converted to an automatic transmission is rather expensive, therefore vehicles with a manual transmission sell at a lower value than automatic vehicles. For each of the Qualitative Characteristics there are well defined industry estimates that can be used to determine the impact on the value of a vehicle assessment.

The Quantitative Characteristics may be analyzed using a Quantitative Analysis Engine 106. The Quantitative Analysis Engine may be a module that performs an analysis of the Quantitative Characteristics based on one or more rules. The rules may be configurable and encoded with business logic where values and weights of different Quantitative Characteristics may be derived from historic data and other factors.

A monetary amount Qt may be derived 107. This may be a monetary amount that represents the dollar amount that will be required to repair or replace the Quantitative factors being considered e.g. if the tires on the vehicle are worn out and require replacement, determine the dollar amount that will be needed to get new tires. Thus Qt will be a sum of all such individual amounts.

The Qualitative Characteristics may be analyzed using a Qualitative Analysis Engine 108. The Qualitative Analysis Engine may be a module that performs an analysis of the Qualitative Characteristics based on one or more rules. The rules may be configurable and encoded with business logic where values and weights of different Qualitative Characteristics may be derived from historic data and other factors that may impact the valuation of a vehicle.

A monetary amount Ql may be derived 109. This may be a monetary amount that represents the dollar amount that will be required to repair or replace the Qualitative factors being considered. For example if the vehicle is manual then historically it is assessed at a lower value than a similar vehicle that has automatic transmission. Thus Ql will be a sum of all such individual amounts.

An assessment for the vehicle may then be determined 110. In one embodiment in order to calculate the assessed value of a vehicle subtract the amounts Qt and Ql from the MPWV of the vehicle that is being assessed.

In another embodiment in order to calculate the assessed value of a vehicle factors or ratios may be used instead of the dollar amounts, in which case the following formula may be used:

Assessed Value=MPWV*[1−{Σ(Quantitative Modifiers)+Σ(Qualitative Modifiers)}]

A Quantitative Modifier may be the ratio of the cost it may take to repair/replace an item and the MPWV, and a Qualitative Modifier may be a ratio of the value and the MPWV.

After deriving an assessment of the vehicle, the assessed value may be displayed (or otherwise communicated) to the user e.g. using a graphical user interface that may be part of the app. The assessment value of a vehicle may be displayed using a currency of the country or location where the vehicle is being assessed. For example in the US display the assessed value in US dollars, while in EU display the assessed value in Euros.

The preferred embodiment may provide a graphical user interface using which a user may request for a vehicle assessment. For example there may be a drop down menu or a list with selection radio buttons, free form text box where vehicle identification information e.g. VIN may be entered. The GUI may also use any other user friendly method that is conducive for use on mobile devices especially ones with touch screens.

In one embodiment there may be an application either generic or purpose built, using which a user may interact with the functionality provided by the system. The application may be specific for a particular mobile device e.g. an iPhone or a Google Android phone, or a tablet computer etc. or generic e.g. Flash or HTML5 based app that can be used in a browser.

In one embodiment a vehicle's assessed value may be received via e-mail if the user requesting the assessment does not have the app installed on his mobile device.

In one embodiment the vehicle may be assessed as often as needed, or may also be assessed on demand or when a certain condition is met.

In one embodiment the assessed value of a vehicle has a given shelf life, after which duration that vehicle valuation expires and a new valuation may be required. For example a vehicle's assessed valuation may expire in 4 weeks from the date it was initially calculated.

The electronic message containing the assessed value of a vehicle may be sent to the user via the app. If a user does not have the app installed on their mobile device, the message may be sent in an e-mail preferably along with a link to download the app.

In other embodiments the electronic message containing the assessed value of a vehicle may also be presented to the user via an e-mail, a text message, a voice mail, a link being added to the homepage on a social media website e.g. Facebook homepage.

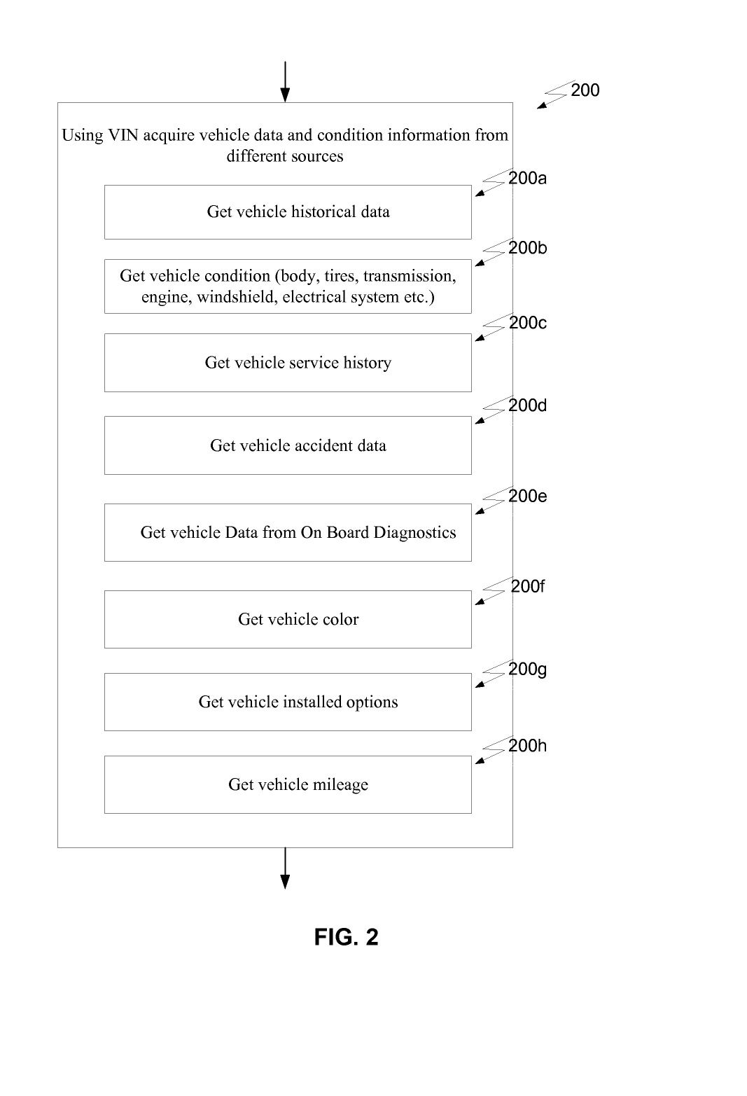

FIG. 2 shows the factors considered when using VIN data is acquired from third parties 200. Vehicle information including a vehicle's make, model, year, installed options, mileage, color, region where the vehicle is from etc. may have an impact on the assessed value. The aforementioned list of factors is exemplary and in other implementations different factors may be used. The invention is not limited to these examples but the intent is to cover all such factors that can influence the assessed value of a vehicle. Additionally any number of different combinations and permutations of these factors may be used in other embodiments when determining the assessed value of a vehicle.

Vehicle data and condition information is acquired from different sources 200. In one embodiment when calculating the assessed value of a vehicle additional information like its specific installed options; its condition e.g. any accidents, any dents, any paints jobs, any major or minor repairs etc; its history e.g. whether the vehicle is single owner, multi-owner, was it a previous daily rental, the region where the vehicle was driven etc. any major or minor recalls of the vehicle by the manufacturer may be used amongst other things. Such data may be acquired from third parties by querying their online databases using VIN of the vehicle being assessed.

This list is exemplary and is not indented to be exhaustive, in fact the intent is to cover all such sets of information that are known to the ones skilled in the art and may be useful in determining the assessed value of a vehicle.

Vehicle historical data is acquired 200a. Such data may be acquired from third parties. Examples of such third parties from vehicle history data may be acquired are Carproof, Experian (Autocheck) and CarFax. Such third parties may provide vehicle history data that may include but is not limited to registration, accidents, liens, title (rebuilt, stolen, flooded).

Vehicle condition (body, tires, transmission, engine, windshield, electrical system etc.) is acquired 200b. Such data may be acquired from automatic sources e.g. from On Board Diagnostics (OBD). Alternatively in another embodiment such data may be acquired by using image/photo analysis of multimedia of the vehicle. In yet another embodiment the condition data may be user provided such that there is an app that helps a user capture such information by using a wizard to step a person from one element to the next.

Vehicle service history is acquired 200c. Such data may be acquired from third parties. Major repairs to a vehicle may reduce its assessed value, while normal maintenance performed at prescribed intervals such as oil changes, tune ups and replacement of belts and hoses etc. may contribute positively in the assessment of the value of a vehicle. Examples of such third parties from vehicle service history may be acquired are dealerships, authorised repair workshops, etc.

Vehicle accident data is acquired 200d. Such data may be acquired from third parties. Examples of such third parties from vehicle accident data may be acquired are Carproof, Experian (Autocheck) and CarFax.

Vehicle data is acquired from On Board Diagnostics 200e. Such data may be obtained from a vehicle by plugging devices to the standard On Board Diagnostics ports that are available in most newer vehicles.

Vehicle color is acquired 200f. This may be acquired automatically by analyzing photos or videos of a vehicle. In another embodiment information about vehicle color data may be provided by a user.

Vehicle installed options are acquired 200g. Such information may be acquired from third parties. Examples of such third parties from where vehicle installed options information may be acquired are dealerships, authorised repair workshops, etc. In another embodiment information about vehicle installed option may be provided by a user.

Vehicle mileage is acquired 200h. The vehicle mileage data may be acquired from On Board Diagnostics (OBD). Alternatively in another embodiment vehicle mileage data may be acquired by using image/photo analysis of odometer. In yet another embodiment the vehicle mileage may be user provided.

FIG. 3 shows one embodiment 300 including sample factors that may be used in determining the Maximum Potential Wholesale Value. A Maximum Potential Wholesale Value (MPWV) for a vehicle is determined 301. In one embodiment the MPWV of a vehicle may be the maximum value that a vehicle of that make, model, year may be assigned if its overall condition, history etc. are in perfect order and no negative factors e.g. dents or damage that can devalue it can be found. A real vehicle may in reality never be assessed to a value that is either equal to or greater than the MPWV.

The assessed value of a vehicle is dependent on its make, model, year, mileage, installed options amongst other factors and the region where the vehicle had been used in the past. For example a vehicle with a given make, model, year that was driven in Los Angeles, Calif. may be assessed at a higher value than a similar vehicle with the same make, model and year that was driven in New York, N.Y. This difference in price may be due to worse winter conditions in NY and the use of salt on the roads in the winter which may make the vehicle's body prone to corrosion and rust.

Sales transactional data may be considered 302. For example, how much did sellers get for same make/model/year vehicle in different markets. Such transactional sales data may be acquired from third parties over a period of time and stored in a local database for analysis and later use.

Other elements that may aid sales transactional data or similar information may include but are not limited to the following:
Manufacturer's suggested retail price (MSRP): This is the price suggested by the manufacturer, and includes the destination charge for the vehicle and the minimum required equipment cost.
Dealer invoice: This is the price the manufacturer charges the dealer for the car. It doesn't include dealer expenses such as advertising, sales commission, and preparing the vehicle for display.
Blue book value: This is the average selling price of the vehicle, taken from actual sales of the vehicle from dealers throughout the country. Often, there are regional price differences, due to variations in demand. A convertible in Seattle might be cheaper than one in San Diego.
Retail value: This is the average listing price by dealers around the country. This is the typical “asking” price on the vehicle, and the actual selling price may usually be less.
Trade-in value: This is the typical price that a dealer would offer for a used vehicle. The trade-in value is usually lower than what a private buyer may pay for this vehicle.

The system may also consider how long the vehicle model has been in the market 303. For example if the model has been in the market for a long time its assessed value may be lower (therefore a certain amount may be deducted from the MPWV in proportion to the age of the model).

The system may also consider whether a new model has arrived in the market, or is arriving soon 304. For example when a new model arrives, the older models automatically get devalued as more people want to buy the newer model of the vehicle.

The system may also consider whether the model of the vehicle has been discontinued 305. For example when a vehicle's model has been discontinued it may automatically be devalued as fewer people want to buy a discontinued vehicle.

The system may also consider seasonality 306. For example, convertible vehicles sell better in spring time than in late autumn, or all wheel drive SUVs sell better just before and during a snowy winter. Thus when calculating MPWV, consider how the vehicle being assessed compares to the season and the trends associated with the season.

The system may also consider economic trends 307. For example, job situation, job creation or job losses, national debt may be factors that are considered. Also, whether people are buying luxury vehicles or low cost fuel efficient vehicles. Thus when calculating MPWV consider how the vehicle being assessed compares with the current economic trends e.g. a luxury vehicle may be assessed at a lower value in tough economic times when jobs are being lost. Fuel costs may also be a factor. For example, when the prices of fuel go up smaller vehicles with better fuel efficiency, or hybrid vehicles may sell better than vehicles that are large and consume lots of gas. Thus when calculating MPWV, the engine size of the vehicle as compared to more efficient vehicles may be factored in. Therefore a vehicle with a 4.2 liter 8-cylinder engine may be assessed a lower value as the price of gas goes up and people prefer a vehicle that has a smaller engine e.g. a 1.6 liter 4-cylinder engine.

The system may also consider cultural trends 308. For example, at a given time smaller vehicles may be trendy, or vehicles with 2 doors with a hatch back may be trendy. When calculating MPWV, consider how the vehicle being assessed compares to the cultural trends. Thus a trendy vehicle may be given a higher assessed value than the one that is out of fashion.

The system may also consider environmental factors and trends 309. For example, increased awareness of the contribution of vehicle emissions and smog may drive popularity of certain more efficient (or lower emission) vehicles. When calculating MPWV consider how the vehicle being assessed compares in terms of its features with the environmental trends i.e. are the emissions high (e.g. large engine size and primary fuel is gas), low (e.g. smaller engine size and hybrid technology) or zero (e.g. an electric car).

The system may consider automotive industry trends, news, and announcements 310. For example automotive industry trends may include shifts in consumer demand, newer designs and features such as in-vehicle WiFi, changes to materials e.g. replacement of steel with aluminum for the vehicle frame, government regulations e.g. new regulations and changes to existing regulations on emissions; news about automotive companies, their financial forecasts, reviews of new models; announcements such as recalls e.g. safety recalls and vehicles that are affected by such recalls and the like.

Finally, from all the factors considered, a MPWV of the vehicle may be determined 311. For each of the factors considered a dollar amount may be either added or subtracted depending if that particular feature is an advantage or a disadvantage respectively.

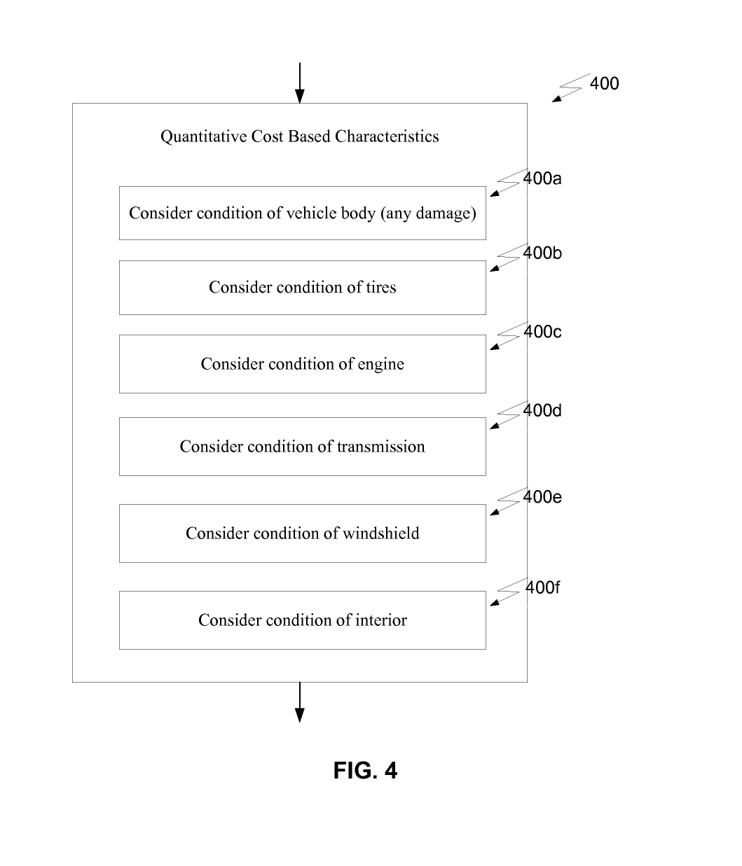

FIG. 4 shows sample factors considered for quantitative cost characteristics (quantitative modifiers) 400. As mentioned earlier, Quantitative Cost based Characteristics or Quantitative Characteristics may be defined as features of a vehicle that can be dealt with given a fixed amount of money.

There is a well defined dollar figure (or a well defined range of dollar figure) that can be used to determine if that particular element (tires, windscreen, dent, broken taillight or headlight, etc.) needs to be replaced, repaired, etc.

For example if a vehicle has a broken windshield it can be quite accurately determined what it will cost to get a new genuine or aftermarket windshield for that particular vehicle. In one embodiment several of a vehicle's features may be considered to determine the total for all Quantitative Cost Based Characteristics.

The system may consider the condition of the vehicle body (any damage) 400a. For example, the condition of the vehicle body and any damage that it may have sustained over its life may be considered. For example if there are any dents or if there is any rust then the system may calculate the dollar amount that it may take to repair that damage.

The system may consider the condition of the tires 400b. For example if the tires are worn out then calculate the dollar amount that it may take to replace them.

The system may consider the condition of the engine 400c. For example the condition of the vehicle's engine and any damage or major repairs that it may have had over the life time of the vehicle may be considered. For example if the engine requires a tune up then the system may calculate the dollar amount it may take to tune up the vehicle.

The system may consider the condition of the transmission 400d. For example the condition of the vehicle's transmission and damage or major repairs that it may have had over the life time of the vehicle may be considered. For example if the transmission needs repairs or replacement, then the system may calculate the dollar amount it may take to repairs or replace the vehicle's transmission.

The system may consider the condition of the windshield 400e. For example if the windshield has any chips or cracks in it and requires a replacement then the system may calculate the dollar amount it may take to replace the windshield.

The system may consider the condition of the interior 400f. For example if the seats have stains then calculate the dollar amount it may take to clean the seats; and if the seats are ripped and require new covers then the system may calculate the dollar amount it may take to install new seat covers in the vehicle.

In one embodiment using the Quantitative Analysis Engine the vehicle may be analyzed for one or more Quantitative Characteristics. For each element that requires repair or replacement, the system may calculate the dollar amount required to fix that feature, for example if a vehicle has broken taillight what it will cost to replace it.

Qt=Σ(Dollar amounts for all Quantitative Characteristics)

In one embodiment each Quantitative Characteristic may have a weight and its weight can be determined by following formula

$$Weight Ratio = \frac{cost estimate to repair}{MPWV}$$

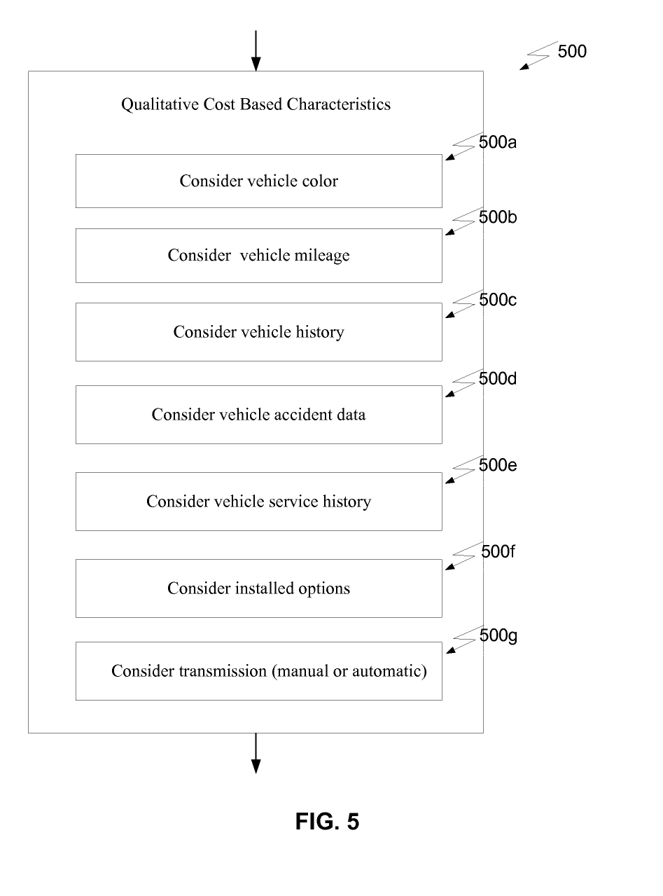

FIG. 5 shows sample factors considered for qualitative cost characteristics (qualitative modifiers) 500. As mentioned earlier, Qualitative Characteristics may be defined as features of a vehicle that cannot easily be modified for example its color or the type of transmission. For example if a vehicle has a color that is rather unique e.g. pink, purple, etc. it can be quite accurately determined that the assessed value of that vehicle will be lower than the same vehicle if the color was a mainstream color e.g. black, white, silver, red etc. Similarly vehicles with a manual transmission sell at a lower value than automatic vehicles. For each of the Qualitative Characteristics there are well defined industry estimates that can be used to determine the impact on the value of a vehicle assessment.

The system may consider the vehicle color 500a. The color of the vehicle may be compared to the mainstream colors and the current color trends for vehicles (or vehicles of a certain type). For example if the color of the vehicle is a mainstream color like black or silver it may be assessed at a higher value, than the same vehicle if the color was unique e.g. pink if pink is not a trendy color at the current time.

The system may consider the vehicle mileage 500b. For example if the vehicle has high mileage then may be assessed at a lower value than a similar vehicle that has low mileage. In one embodiment the difference in the assessed value may be in proportion to the mileage.

The system may consider the vehicle history 500c. History may include but is not limited to vehicle title history, the number of previous owners, who those owners were etc. For example if the vehicle is a single owner vehicle, then it will be assessed at a higher value than a vehicle that has had multiple owners. Similarly if a vehicle was a previous daily rental it may be assessed at a lower value.

The system may consider the vehicle accident data 500d. Vehicle accident data may be acquired from third party providers, and may include information whether the vehicle has had any accidents in the past. For example if a vehicle had a major accident and has been repaired, its assessed value may be lower than a similar vehicle that has not had any accidents.

The system may consider the vehicle service history 500e. Vehicle service history may be acquired from third party providers like dealerships, and may include information whether the vehicle has had regular maintenance performed at the prescribed intervals as suggested by the manufacturer. For example if a vehicle has not been regularly serviced and was not serviced at the dealership, its assessed value may be lower than a similar vehicle that has been serviced regularly at the dealership.

The system may consider the vehicle's installed options 500f. For example if the vehicle does not have leather seats and navigation then its assessed value may be lower than a similar vehicle that has leather seats and navigation installed in it.

The system may consider the vehicle transmission type (Manual or Automatic) 500g. For example if the vehicle has manual transmission then its assessed value may be lower than a similar vehicle that has automatic transmission.

In one embodiment using the Qualitative Analysis Engine the vehicle may be analyzed for one or more Qualitative Characteristics. For each element, a value may be calculated. For example if a vehicle has purple color, has high mileage and has a manual transmission then:

Ql=Σ(Dollar amounts for all Qualitative Characteristics)

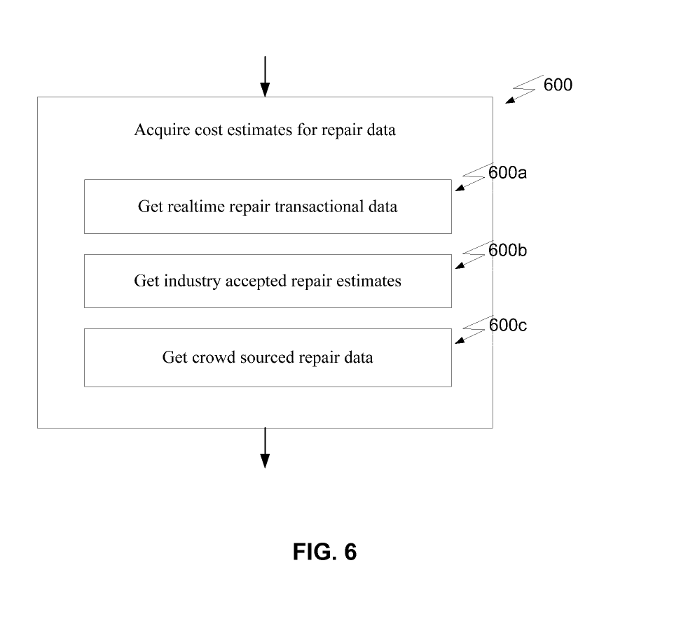

FIG. 6 shows various sources for cost estimate data. Cost estimates for repair data may be acquired 600. In order to get the best estimates for repair costs information may be obtained from more than one sources, such sources may be internal e.g. data gathered over a period of time or such sources may be external and third party provided.

Realtime repair transactional data may be acquired 600a. Such data may be acquired from third parties e.g. dealerships, repair workshops etc.

Industry accepted repair estimates may be acquired or used 600b. Such data may be acquired from third parties.

Crowdsourced repair data may also be acquired or used 600c. For example, an interface may be provided using which scores of people in the broad user community (crowd) may provide the actual cost of the repairs that may have had on their vehicles. In one embodiment in order to verify the data added by the crowd, people may be asked to provide a scanned copy of the actual bills or receipts of the repair work they may have had performed on their vehicles.

In the preferred embodiment the following may be used to calculate the assessed value of a vehicle:

Assessed Value of a Vehicle=MPWV−(Qt+Ql)

Where:

MPWV=Maximum Potential Wholesale Value for the vehicle

Qt=Σ(Dollar amounts for all Quantitative Characteristics) and

Ql=Σ(Dollar amounts for all Qualitative Characteristics)

In another embodiment in order to calculate the assessed value of a vehicle, factors or ratios may alternatively be used, instead of the dollar amounts, in which case the following formula may be used:

Assessed Value=MPWV*[1−{Σ(Quantitative Modifiers)+Σ(Qualitative Modifiers)}]

In another embodiment a Quantitative Modifier is ratio of the cost it may take to repair/replace an item and the MPWV, and a Qualitative Modifier is a ratio of the value and the MPWV.

In one embodiment the location of the person requesting the vehicle assessment may optionally be considered when calculating the assessed value of a vehicle. For example if a certain vehicle is in Miami Fla. and a first user requesting the vehicle assessment in New York, N.Y. will get a vehicle assessment based on the value of that particular vehicle in New York, N.Y.; while a second user requesting the vehicle assessment in Sacramento Calif. will get a vehicle assessment based on the value of that particular vehicle in Sacramento Calif. Thus the vehicle assessment derived from FIG. 1 may be modified to take the location of the user requesting the vehicle assessment into account.

In one embodiment there may be a time limit after which the assessed value of a vehicle may be expired e.g. 3 months. Preferably this time limit may be configurable. Preferably the expiry time may also be configurable and based on the other factors e.g. market volatility. Thus if prices are changing rapidly, then the assessed value may have a shorter shelf life.

In one embodiment preferably the historical data may be stored in the system and accumulates over time as more data about the values of vehicles is accumulated. Alternatively such data may also be acquired from third parties in bulk and then refreshed from time to time as needed.

In one embodiment the system may also provide a notification service. The notification service may provide a notification to a user who had asked for a vehicle assessment. The notifications/reminders from the notification service may be presented to the user via in-app messaging, e-mail, text message, phone call, voicemail, or via social networks e.g. Facebook page, Google+, Twitter etc. by preferably adding a link on the homepage of a bidder/seller on a social media website e.g. Facebook homepage. The notification service of the system may also provide periodic reminders.

These descriptions exemplify only some of the several possible embodiments and are not meant to be exhaustive.

It should be understood that although the term application has been used as an example in this disclosure but in essence the term may also imply to any other piece of software code where the embodiments are incorporated. The software application can be implemented in a standalone configuration or in combination with other software programs and is not limited to any particular operating system or programming paradigm described here.

The computer program comprises: a computer usable medium having computer usable program code, the computer usable program code comprises: computer usable program code for presenting graphically to the users options for scrolling via the touch-screen interface.

The examples noted here are only for illustrative purposes and there may be further implementation embodiments possible with a different set of components. While several embodiments are described, there is no intent to limit the disclosure to the embodiment or embodiments disclosed herein. On the contrary, the intent is to cover all practical alternatives, modifications, and equivalents.

1. A method of computer-mediated value assessment of a vehicle offered for sale by a seller, the vehicle having at least one parameter, the method comprising:
retrieving, by a computing device, a universe of historical pricing data of vehicles having the same or similar at least one parameter, and from the universe of historical pricing data of vehicles having the same or similar at least one parameter, establishing a maximum potential wholesale value;
using a vehicle identification number of the vehicle to retrieve data regarding the vehicle and its condition;
converting the data into at least one quantitative modifier, and at least one qualitative modifier;
reducing the maximum potential wholesale value by the at least one quantitative modifier and the at least one qualitative modifier to arrive at an assessed value of the vehicle; and
communicating the assessed value to a person requesting an assessment prior to a sale of the vehicle.

2. The method of claim 1, wherein the at least one parameter includes at least one of make, model, or year.

3. The method of claim 1, wherein establishing a maximum potential wholesale value takes into account at least one of sales transactional data, length of time vehicle model in the market, whether new model has arrived in market, whether model discontinued, seasonality, economic trends, cultural trends, environmental factors and trends, automotive industry trends, news, and announcements.

4. The method of claim 1, wherein the at least one quantitative modifier includes a modifier related to condition of body, tires, engine, transmission, windshield, or interior.

5. The method of claim 1, wherein the at least one qualitative modifier includes a modifier related to vehicle color, mileage, history, accident data, service history, installed options, or type of transmission.

6. The method of claim 1, wherein the quantitative modifier is a monetary value.

7. The method of claim 6, wherein the monetary value is an estimated or actual cost to replace, repair or upgrade a quantitative characteristic of the vehicle.

8. The method of claim 7, wherein the cost is derived from at least one of realtime repair transactional data, industry accepted repair estimates, or crowdsourced repair data.

9. The method of claim 1, wherein the quantitative modifier or the qualitative modifier is a ratio relative to the maximum potential wholesale value.

10. The method of claim 1, wherein the vehicle identification number is entered using at least one of a barcode scanner, digital camera, on board diagnostics, or user input.

11. The method of claim 1, wherein the data is retrieved by querying the vehicle identification number in a third party database.

12. The method of claim 1, further comprising detecting or retrieving the location of the person requesting the assessment.

13. The method of claim 12, wherein the assessment is modified to take account of the location of the person requesting the assessment before the assessment is communicated.

14. The method of claim 12, wherein the assessment is communicated to the person requesting the assessment in a legal currency of the location.

15. The method of claim 1, wherein the assessed value is communicated with an expiration date.

16. The method of claim 15, further comprising allowing the person requesting the assessment to transact with respect to the vehicle at the assessed value until the expiration date.
